(19) United States
(12) Patent Application Publication
(10) Pub. No.: US 2006/0292945 A1
(43) Pub. Date: Dec. 28, 2006

(54) Alternate/reduced scrim for single ply roofing membrane

(75) Inventors: William P. Kuhn, Stonington, CT (US); Edward Nebesnak, Mine Hill, NJ (US); Li-Ying Yang, Whippany, NJ (US)

Correspondence Address: GAF MATERIALS CORPORATION;Attn: William J. Davis, Esq., Legal Department, 1361 Alps Road, Building No. 8, Wayne, NJ, 07470, US

(73) Assignee: BUILDING MATERIALS INVESTMENT CORPORATION

(21) Appl. No.: 11/168,954

(22) Filed: Jun. 28, 2005

(51) Int. Cl. B32B 27/12; B32B 27/02; B32B 27/04

(52) U.S. Cl. 442/38; 442/20; 442/27; 442/41; 442/43; 442/45; 442/46; 442/49; 442/50; 442/54; 442/58

(57) ABSTRACT

A reduced scrim reinforcement is provided in single ply roofing membranes having excellent wind uplift performance. Also provided is a method for making a roofing membrane having the scrim reinforcement incorporated therein.

### FIELD OF THE INVENTION

The present invention relates to roofing membranes. More specifically, the present invention relates to a cost-effective scrim reinforcement in single ply roofing membranes having excellent wind uplift performance for fully adhered roofing systems, as well as a method for making a roofing membrane having the scrim reinforcement incorporated therein.

### BACKGROUND OF THE INVENTION

A single ply building membrane is a membrane typically applied in the field using a one layer membrane material (either homogeneous or composite) rather than multiple layers built-up. These membranes have been widely used on low slope roofing and other applications. The membrane can comprise one or more layers, have a top and bottom surface, and may include a reinforcing scrim or stabilizing material. The scrim is typically of a woven, nonwoven, or knitted fabric composed of continuous strands of material used for reinforcing or strengthening membranes.

These single ply membranes typically comprise base (bottom) and cap (top) polyolefin-based sheets (layers) with a fiber reinforcement scrim (middle) sandwiched between the other two layers. The scrim is generally the strongest layer in the composite. Other materials from which the membranes may be formed, include but are not limited to, polyvinyl chloride (PVC), chlorosulfonated polyethylene (CSPE or CSM), chlorinated polyethylene (CPE), and ethylene propylene diene terpolymer (EPDM).

A typical method of preparing these membranes comprises the steps of unwinding a support sheet, scrim or stabilizing material, coating the support by extrusion of a molten compounded polymers, adding one or more fillers, cooling and solidifying the membrane, and winding the membrane into a roll.

Currently, the single ply membrane market uses a scrim reinforcement of 9×9 1000 denier scrim. Denier is a measure of weight in grams per 9000 meters of yarn. 9×9 is the number of strands per inch in the MD (machine direction) and CMD (cross machine direction). However, the cost of the scrim in the single ply membrane can be significant, as thermoplastic olefin (“TPO”) becomes a commodity in the industry.

### SUMMARY OF THE INVENTION

The present invention relates to a scrim having substantially the same wind uplift performance as existing scrim but which utilizes less scrim when incorporated in membranes. The scrim is typically of a woven, nonwoven, or knitted fabric composed of continuous strands of material used for reinforcing or strengthening membranes. More particularly, the present invention provides a 6×6 1000 denier polyester scrim for incorporation in a single ply membrane. The 6×6 1000 denier scrim in accordance with the present invention costs less than the presently utilized 9×9 1000 denier scrim and does not lose any wind uplift performance based on the reduced number of strands per inch in the MD (machine direction) and CMD (cross machine direction).

Those in the roofing industry understand the importance of scrim reinforcement on wind uplift performance of mechanically attached system. Mechanically attached membranes utilize screws, plates, battens, nails, or other materials to secure roofing materials to a roof surface. The wider the roofing membrane, however, the stronger the reinforcement required to maintain the same wind uplift performance. The conventional manner of increasing scrim strength is by increasing the denier of the filaments or increasing number of strands per inch.

For the fully adhered roofing system in which the membrane is fully attached to the roof surface, scrim strength requirement is significantly less to achieve the same wind uplift performance as in the mechanically attached roofing. For fully adhered roofs, a water or solvent-based adhesive may be field applied to secure the membrane to the substrate. Alternatively, the membrane can be supplied with a factory-applied adhesive with a release liner. A typical solvent based adhesive is a solvent based butyl rubber and aliphatic/aromatic hydrocarbon adhesive. An exemplary water-based adhesive is water-based vinyl acetate adhesive. A factory-applied adhesive tape may be a butyl type of hot melt adhesive in the thickness of 5-15 mils.

Accordingly, a single ply roofing membrane is provided, comprising a top layer of a membrane, a bottom layer of a membrane, and a reduced scrim positioned or embedded between the top and bottom layer. The reduced scrim is in the range of from approximately 6×6 to 9×9 1000 denier scrim. Preferably, the reduced scrim is 6×6 1000 denier.

The present invention is also directed to a method of preparing a roofing panel having a reduced scrim, the method comprising the steps of: unwinding a first layer of a membrane, unwinding a 6×6 1000 denier scrim upon the first layer of membrane, coating the scrim by extrusion of a molten compounded polymers, optionally adding one or more fillers, unwinding a second layer of a single play membrane upon the scrim; cooling and solidifying the membrane, and winding the membrane into a roll.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE FIGURE

These and other features, aspects, and advantages of the apparatus and methods of the present invention will become better understood with regard to the following description, appended claims, and accompanying drawings where:

FIG. 1 illustrates one embodiment of the scrim in accordance with the present invention; and

FIG. 2 is an exploded perspective view of a scrim positioned between top and bottom layers of a single ply membrane.

### DETAILED DESCRIPTION OF THE FIGURES

Although this invention is applicable to numerous and various roofing structures, it has been found particularly useful in the environment of single ply roofing membranes. Therefore, without limiting the applicability of the invention to single ply roofing membranes, the invention will be described in such environment.

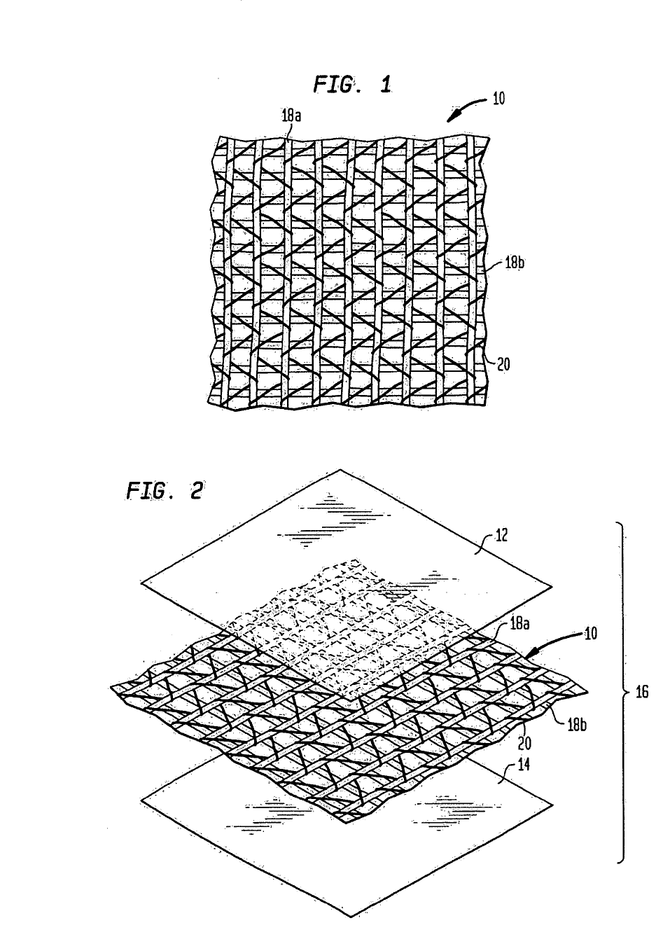

With reference now to the drawing, the components of the present invention will be described. FIG. 1 shows a sheet of scrim 10 in accordance with one embodiment of the present invention. In FIG. 2, scrim 10 is shown as it would be positioned between an upper layer 12 and a lower layer 14. Upper layer 12 and lower layer 14 are generally cohered to each other with the scrim 10 sealed in between to form membrane 16. Layer 12, 14 are generally flexible materials and may include, but are not limited to, polyolefin-based sheets, as well as polyvinyl chloride (PVC), chlorosulfonated polyethylene (CSPE or CSM), chlorinated polyethylene (CPE), and ethylene propylene diene terpolymer (EPDM).

Layers 12, 14 may also be thermoplastic membranes preferably polyvinyl chloride (PVC) and other resinous compositions containing polyvinyl chloride, chlorosulfonated polyethylene (CSPE or CSM), chlorinated polyethylene (CPE), ethylene propylene diene terpolymer (EPDM), or a thermoplastic olefin (TPO).

Typically, membrane 16 is a single-ply TPO, with an intermediately embedded reinforcing low-stress weft-inserted fabric in which the mounting area is along a longitudinal, warp-thread directional edge of each membrane.

The typical thickness of membrane 16 is in the range of from 0.030 to 0.1 inches. In one embodiment, each layer 12 and 14 has a thickness in the range of 0.015 to 0.050 inches, and is formulated from TPO resin. Each of layers 12 and 14 may include and contain in the extrusion mix UV stabilizers, antioxidants, and fire retardants, such as taught in U.S. Pat. No. 6,544,909, which is incorporated by reference herein in its entirety. Membrane 16 is in the range from approximately 3 feet to 12 feet wide and 100 to 600 feet in length. Layers 12, 14 may be provided with a top composition that provide durable exterior protection. Examples of top compositions include compositions having intumescent and reflective properties.

Scrim 10 is generally formed from strands 18a, 18b, and 20 which are parts of a fabric reinforcing layer. Strands 18a are in the warp (length) direction and strands 18b are oriented in the weft (cross machine) direction or 90 degrees to the warp strands 18a. Strands 18a and 18b are stitched together at the crossing point by the tie strand 20. Scrim 10 is typically of a woven, nonwoven, or knitted fabric composed of continuous strands of material used for reinforcing or strengthening membranes. Low-elongation strands can be provided in the direction parallel to one pair of membrane edges. The plastic resin composition can consist of chlorinated polyethylene containing titanium dioxide and no plasticizer and/or a foraminous, stressfree reinforcing layer. The membrane may be a single-ply TPO, with an intermediately embedded reinforcing low-stress weft-inserted fabric in which the mounting area is along a longitudinal, warp-thread directional edge of each membrane. The ultra-high-molecular-weight polyethylene (UHMWPE) threads can be warp strands and the mounting area can also include warp threads of lower tenacity and lower breaking strength, fill threads being throughout the membrane of lesser breaking tenacity than the ultra-high-molecular-weight polyethylene strands. The warp and weft threads 18a, 18b throughout scrim 10 are singletons of 500-1500 denier polyester or other reinforced fibers. The preferred threads are with 1000 denier polyester. Effective thread count in this invention is 6×6 throughout (both warp and fill) membrane 16, six per inch throughout the sheet.

Membrane 16 may include one or more molten polymers incorporated between layers 12, 14, and may optionally include one or more fillers. Molten polymers that may be incorporated in membrane 16 include, but are not limited to thermopasltic polyolefins (TPO), polyvinyl chloride (PVC), chlorosulfonated polyethylene (CSPE or CSM), chlorinated polyethylene (CPE), and ethylene propylene diene terpolymer (EPDM). Exemplary fillers which may be incorporated in membrane 16 include, but are not limited to, carbon black, titanium dioxide, calcium carbonate and inorganic fire retardants such as magnesium hydroxide and alumina trihydroxide.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

### EXAMPLE

Wind Uplift Performance with Reduced Scrim for a Fully Adhered System

A standard single ply TPO roofing membrane was made with a 9 by 9 1000 by 1000 weft inserted warp knit polyester reinforced scrim. An alternate single ply TPO roofing membrane in the present invention was made with a 6 by 6 1000 by 1000 weft inserted warp knit polyester reinforced scrim.

A standard self-adhered TPO membrane was made with standard TPO membrane laminated with the adhesive tape on the back. An alternate self-adhered TPO membrane was made with alternate TPO membrane in the present invention laminated the adhesive tape on the back.

The adhesive tape is a butyl type of hot melt adhesive in the thickness of 5-15 mils.

Two self-adhered TPO roofing membranes were tested for the wind uplift performance according to Factory Mutual (FM) standard 4470. The data in the following table showed the excellent wind uplift performance achieved by the alternate self-adhered TPO roofing membrane made with the reduced scrim in invention example. The physical properties of said self-adhered TPO membrane of the present invention also meet the ASTM D6878 TPO roofing specification.

| Self-Adhered TPO | | |
|---|---|---|
| Roofing Membrane | Standard Example | Invention Example |
| Wind Uplift Rating | I-105 | I-135 |
| (Lbs/SF) Per FM standard | | |
| 4470 | | |

1. A roofing panel, comprising:
a. a top layer of a membrane;
b. a bottom layer of a membrane;
c. a 6×6 1000 denier reduced scrim embedded between the top and bottom layers;
wherein the reduced scrim comprises woven, nonwoven, or knitted fabric composed of continuous strands of material selected from the group consisting of polyester, polyethylene, polyamide and fiberglass.

2. (canceled)

3. (canceled)

4. The panel as recited in claim 1, further comprising a polymer disposed upon the scrim between the top and bottom membrane layers.

5. The panel as recited in claim 1, wherein the top and bottom membrane layers are flexible sheets selected from the group consisting of polyolefin, polyvinyl chloride (PVC), chlorosulfonated polyethylene (CSPE or CSM), chlorinated polyethylene (CPE), and ethylene propylene diene terpolymer (EPDM).

6. (canceled)

7. (canceled)

8. The panel as recited in claim 1, wherein the panel is fully adhered to a roof surface.

9. The panel as recited in claim 8, wherein the panel is fully adhered to a roof surface using adhesive.

10. The panel as recite in claim 9, wherein the adhesive can be field applied or factory applied with a release liner.

11. A method of preparing a roofing panel having a reduced scrim, the method comprising the steps of:
a. unwinding a 6×6 1000 denier scrim, the scrim having a top and bottom surface
b. coating the scrim by extrusion of a molten compounded polymers and optionally one or more fillers on the top and bottom surfaces of the scrim,
c. cooling the membrane, and
d. winding the membrane into a roll.

12. The method as recited in claim 10, wherein the molten compounded polymers are selected from the group consisting polyolefin, polyvinyl chloride (PVC), chlorosulfonated polyethylene (CSPE or CSM), chlorinated polyethylene (CPE), and ethylene propylene diene terpolymer (EPDM).

13. The method as recited in claim 10, wherein the cooling step results in solidification of the molten compound polymers coated on the scrim.

14. A 6×6 1000 denier scrim for incorporation into a single ply roofing membrane, wherein the reduced scrim comprises woven, nonwoven, or knitted fabric composed of continuous strands of material comprised of polyester.

15. A roofing panel for improved wind uplift performance in fully adhered roofing membranes, comprising:
a. a top layer of a membrane;
b. a bottom layer of a membrane;
c. a 6×6 1000 denier reduced scrim embedded between the top and bottom layers;
wherein the reduced scrim comprises woven, nonwoven, or knitted fabric composed of continuous strands of material selected from the group consisting of polyester, polyethylene, ultra-high-molecular-weight polyethylene (UHMWPE), polyamide and fiberglass.

16. (canceled)

17. (canceled)

18. The panel as recited in claim 15, further comprising a polymer disposed upon the scrim between the top and bottom membrane layers.

19. The panel as recited in claim 15, wherein the top and bottom layer are flexible sheets selected from the group consisting of polyolefin, polyvinyl chloride (PVC), chlorosulfonated polyethylene (CSPE or CSM), chlorinated polyethylene (CPE), and ethylene propylene diene terpolymer (EPDM).

20. (canceled)

21. (canceled)

22. A roofing panel, comprising:
a. a top layer of a membrane;
b. a bottom layer of a membrane;
c. a 6×6 1000 denier reduced scrim embedded between the top and bottom layers;
wherein the reduced scrim comprises woven, nonwoven, or knitted fabric composed of continuous strands of material comprised of polyester.
